(19) United States
(12) Patent Application Publication
(10) Pub. No.: US 2002/0147993 A1
(43) Pub. Date: Oct. 10, 2002

(54) Method and apparatus for legacy analog video interconnections in a set-top box for personal video recording applications

(75) Inventor: David H. Bessel, Poway, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation and Sony Electronics Inc.

(21) Appl. No.: 09/826,198

(22) Filed: Apr. 4, 2001

(51) Int. Cl. H04N 7/16; H04N 5/46

(52) U.S. Cl. 725/151; 348/555

(57) ABSTRACT

A television signal processing system, such as a set-top box and a personal video recorder, that handles both digital and legacy analogy system can be simplified to minimize the required connections between system components. Digital signals are demultiplexed and recorded or decompressed and output to a television set. Analog signals are decoded, or converted to digital, and then compressed. The compressed signal can be demultiplexed and recorded or demultiplexed, decompressed and output to a television set. In either case, only a single connection is required between the processing circuitry and the television set, and between the processing circuitry and the signal recording circuitry and hardware.

### FIELD OF THE INVENTION

The present invention relates to the field of processing and recording broadcast video signals that may contain both digital and legacy analog signals. More particularly, the present invention provides an improved method and means for routing a legacy analog signal in a set-top box connected to or including a personal video recording device.

### BACKGROUND OF THE INVENTION

Television is widely used in modem society as a source of both information and entertainment. Television signals are generally broadcast over-the-air, by satellite and through proprietary cable networks. With over-the-air signals, an antenna is connected to the television set to allow the set to receive the terrestrial broadcast. With cable and satellite system, a Set-Top Box (STB) is usually connected between the television and the cable outlet or satellite dish. The STB is a box of electronics that enables the television set to use the signals received from the cable network or the satellite system.

Originally, all television broadcasts were transmitted as analog signals. However, as broadcast technology has advanced, the industry is gradually migrating toward digital television signals. A digital signal is capable of carrying much more information than an analog signal. Consequently, higher quality images and sound can be broadcast using digital signals. Such high quality digital broadcasts are sometimes referred to as High-Definition Television (“HDTV”).

While high quality digital television broadcasting is clearly the future, the migration to the digital format is expensive in terms of both broadcasting and receiving equipment that must be replaced to handle the newer digital format. Because of this expense, it will certainly be some time before all television signals around the world are broadcast in the digital format. For this reason, it is likely that television equipment manufactured for the general market will be required to handle both digital signals and the older legacy analog signals for a long time to come.

Unfortunately, building a dual-band television receiver that can handle both analog and digital signals adds to the complexity and cost of the television. These problems are further exacerbated by the need for dual-band capability in other equipment that works with the television, such as set-top boxes and television recording equipment. Interconnecting such a system, with multiple pieces of dual-band equipment, can be highly complex and difficult to do efficiently.

Television recording equipment is generally considered necessary because of the enormous wealth of available broadcast programming. Cable and satellite systems can supplement local over-the-air broadcasting to provide dozens or even hundreds of channels of programming, and the amount of programming available will only increase as the digital format, which can carrying so much more data than analog, continues to spread.

With so much programming available, it may be difficult for a viewer to be available to watch all the programming he or she wishes to see at the times those programs are broadcast. Consequently, recording devices have been developed to record broadcast television signals. In this way, the viewer can “time-shift” a program by recording the program when it is broadcast, and then replaying it for viewing at a time convenient to the viewer. These recording devices may be generally categorized as Video Cassette Recorders (VCRs) and Personal Video (or Versatile) Recorders (PVRs).

A VCR uses a magnetic tape to allow the user to record incoming audiovisual programming while watching the same or a different channel. A timer in the VCR allows the user to record broadcast programming according to a pre-programmed recording schedule. As mentioned above, the recording is then available for playback at the user's convenience.

The basic concept of the VCR has been extended to digital compression devices that provide even more features for managing the reception and recording of audiovisual programming. These products have a number of names such as personal television products, personal video recorders, video recording computers, personal television servers, etc. (referred to collectively as “personal video recorders” or “PVRs” hereafter). Current examples of personal video recorders include the TiVo® system made by TiVo, Inc. and the ReplayTV® system made by Replay Networks, Inc.

Personal video recorders replace the video cassette in a VCR with a hard disk drive or other digital memory device internal to the personal video recorder. The personal video recorder is connected between a user's television set and that user's STB, satellite receiver or antenna. The personal video recorder can control the channel tuned on the television, provide an interactive electronic program guide and record programming on a manual or timer-controlled basis. Additionally, the personal video recorder can buffer incoming audiovisual programming so that the viewer can pause a live television program or replay a portion of a live television program without missing any subsequent segment of the program, as long as the pause or replay does not exceed the capacity of the buffer.

Because the personal video recorder records in a digital format on a digital recording medium, e.g. a hard disk drive, the personal video recorder is much more amenable than a VCR to capturing high-quality, digital television signals. However, adapting the personal video recorder to also record analog signals adds additional complexity to the system.

FIG. 1 illustrates a conventional system in which both digital and analog television signals are processed for use by a television set or monitor (106) (hereinafter collectively, “television set”) and also for recording on the hard disk drive (107) of a PVR. As shown in FIG. 1, a television signal (108) is received by the system. This signal (108) may be a composite signal carrying both legacy analog signals as well as digital signals. The signal (108) is provided to two tuners, an analog tuner (101) and a digital tuner (102).

The analog tuner (101) can tune an analog signal at a particular frequency, i.e., a particular channel, from among the many analog channels that may be carried by the composite signal (108). The analog tuner (101) can then output the tuned signal. Similarly, the digital tuner (102) separates out the digital signal for a particular digital channel or program from among the many channels that may be carried by the composite signal (108).

In the analog signal path, the analog signal output by the tuner (101) is first converted into a digital signal by a video decoder (109). The signal can then be output to the television set (106) which is capable of displaying digital audiovisual signals. However, in order for the signal to be recorded by a PVR or on a hard disk drive (107), it must first be compressed. Consequently, the signal may be compressed by, for example, an MPEG2 encoder (105). The signal can then be output to and recorded on a hard disk drive (107).

Digital signals from the digital tuner (102) must be handled differently. Conventionally, the digital signal output by the tuner (102) is demultiplexed by a demultiplexer (103). After demultiplexing, the digital signal, which is compressed before broadcasting, can be sent directly to a PVR or recorded on a hard disk drive (107). For the signal to be displayed by the television set (106), however, it must first be decompressed by an MPEG2 decoder (104). The decompressed digital signal can then be sent to the television set (106) for display.

Obviously, this system of handling both digital and audio signals is complex and, consequently, relatively expensive to implement. Two connections to the television set (106) are required, one for the analog signal channel (101, 108) and one for the digital signal channel (102, 103). Two connections to the PVR or hard disk drive (107) are required, one for the analog signal channel (101, 108) and one for the digital signal channel (102, 103).

Consequently, there is a need in the art for a simpler and more efficient way of routing analog and digital signals through a system that provides output to a television set and a hard disk drive or other digital recording device.

### SUMMARY OF THE INVENTION

The present invention meets the above-described needs and others. Specifically, the present invention provides a simpler and more efficient way of routing analog and digital signals through a system that provides output to a television set and a hard disk drive or other digital recording device.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a television signal processing and recording system for handling both digital and analog video signals. In a preferred embodiment, the system may include a video decoder in an analog signal path for converting an analog signal to a digital signal; an encoder for compressing the digital signal output by the video recorder; and a connection for routing the compressed digital signal into a digital signal path in which the compressed digital signal is either decompressed with a decoder and output to a television set or recorded on a digital data storage device. A demultiplexer is used for demultiplexing the compressed digital signal when the compressed digital signal is routed to the digital signal path. Preferably, the digital data storage device is a hard disk drive.

In a parallel input path, a digital tuner may output a tuned digital signal into the digital signal path. The digital tuner outputs the digital signal to the multiplexer. An analog tuner is preferably used for providing the analog signal to the video decoder. Preferably, the encoder and decoder use the MPEG2 standard.

The decoder, encoder, connection and decoder may be incorporated in a set-top box. While the digital data storage device is incorporated in a personal video recorder. Alternatively, the decoder, encoder, connection, decoder and digital data storage device may be incorporated in a single set-top unit. As another alternative, all the components may be incorporated into a television set.

The present invention also encompasses a method of processing and recording a television signal that handles both digital and analog video signals. The method is performed by converting an analog signal to a digital signal; and compressing and decompressing the digital signal before outputting the digital signal to a television set. After converting the analog signal to the digital signal and after compressing the digital signal, the method includes routing the compressed digital signal from an analog signal path to a digital signal path in which the compressed digital signal is decompressed and output to a television set. After converting the analog signal to the digital signal and after compressing the digital signal, the method may include recording the compressed digital signal on a digital data recording device.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a block diagram of a conventional system for processing analog and digital signals for output to both to a television set and a hard disk drive or other digital recording device.

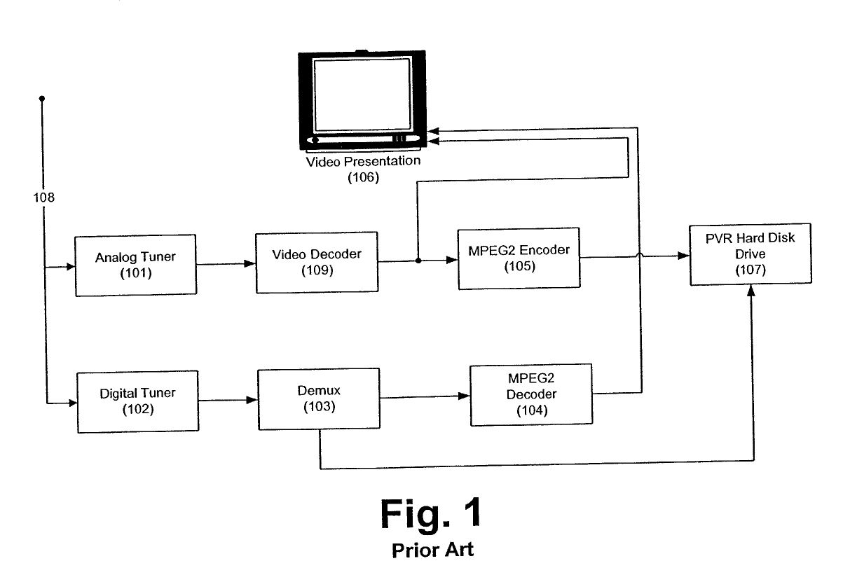

FIG. 2 is a block diagram of an improved system according to the present invention system for processing analog and digital signals for output to both a television set and a hard disk drive or other digital recording device.

FIG. 3 is a block diagram of a first embodiment of the system of the present invention illustrated in FIG. 2.

FIG. 4 is a block diagram of a second embodiment of the system of the present invention illustrated in FIG. 2.

FIG. 5 is a block diagram of a third embodiment of the system of the present invention illustrated in FIG. 2.

FIG. 6 is a flowchart illustrating a preferred method of the present invention.

Throughout the drawings, identical elements are indicated with identical reference numbers.

### DETAILED DESCRIPTION OF THE PREFERRED EMBODIMENTS

Using the drawings, the preferred embodiments of the present invention will now be explained. As used herein, the term “television set” shall refer generally to any television set or video monitor.

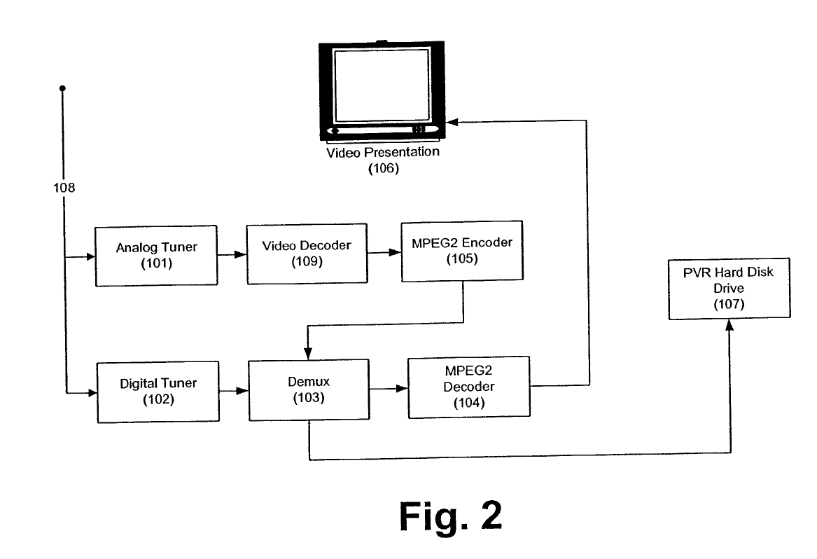

FIG. 2 is a block diagram of an improved system according to the present invention system for processing analog and digital video signals for output to both to a television set and a hard disk drive or other digital recording device.

As shown in FIG. 2, a television signal (108) is received by the system. This signal (108) may be an analog signal, a digital signal or a composite signal carrying both legacy analog signals as well as digital signals. The signal (108) may also be carrying multiple channels of television programming. In order to fully handle the signal (108), irrespective of its components, the signal (108) is provided to two tuners, an analog tuner (101) and a digital tuner (102).

The analog tuner (101) can tune an analog signal at a particular frequency, i.e., a particular channel, from among the many analog channels that may be carried by the composite signal (108). The analog tuner (101) can then output the tuned signal. Similarly, the digital tuner (102) separates out the digital signal for a particular digital channel or program from among the many channels that may be carried by the composite signal (108). The tuners (101, 102) are typically controlled through a user input device, such as a keypad or remote control unit, so that the user can control the channel being selected and tuned.

In the analog signal path, the analog signal output by the tuner (101) is first converted into a digital signal by a video decoder (109). The signal could then be output to a television set (106) which is capable of displaying digital audiovisual signals. However, to simplify the interconnections between system components, the now-digital signal is the compressed with an MPEG2 encoder (105).

The compressed signal is then routed through a demultiplexer (103). From the demultiplexer (103), the compressed signal, which was originally received as an analog signal, can be recorded on a hard disk drive (107) or other digital data storage medium. Alternatively, the signal can be decompressed with an MPEG2 decoder (104) and output to a television set (106) for display.

Having considered the handling of an analog signal by the system of the present invention, we will now consider the handling of a digital signal. Digital signals output by the digital tuner (102) must be handled differently. A digital signal output by the tuner (102) is routed into the same demultiplexer (103) that handles signals from the analog tuner (101) that have been converted to digital and compressed.

After demultiplexing, the digital signal, which was compressed before broadcasting, can be sent to and recorded on a hard disk drive (107) or other digital recording medium. Alternatively, the signal can be decompressed by an MPEG2 decoder (104). The decompressed digital signal can then be sent to a television set (106) for display.

As will be noted by those skilled in the art, the system of the present invention requires only a single connection between the system and the television set (106). Additionally, the system requires only a single connection between the system and a PVR, hard disk drive (107) or other digital recording medium. Consequently, the system of the present invention is much simpler as to the interconnections required than conventional systems with equivalent functionality.

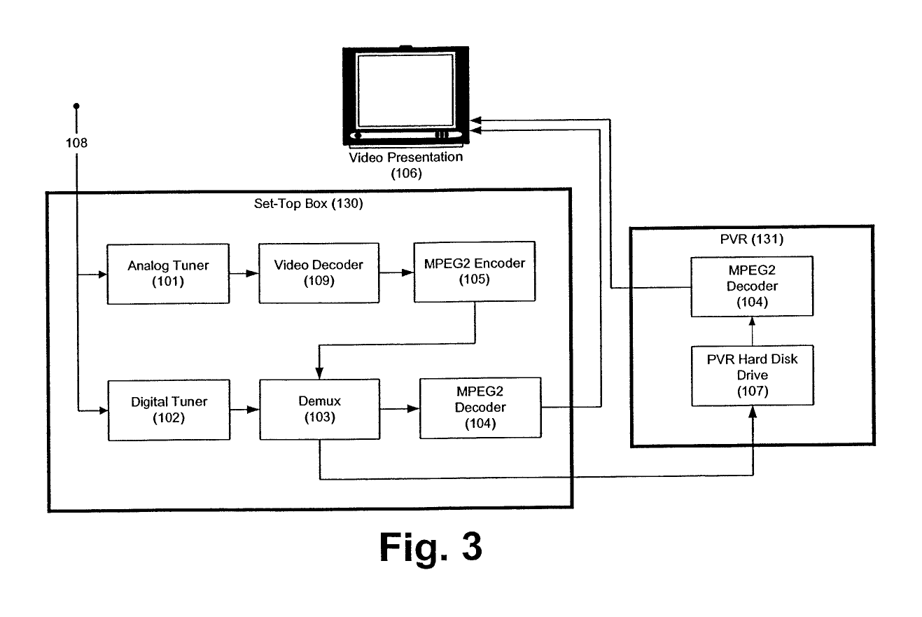

FIG. 3 illustrates a preferred embodiment for the general system described above in connection with FIG. 2. As shown in FIG. 3, the general processing system, including the tuners (101, 102), analog signal path (108, 105) and digital signal path (102, 103, 104), is incorporated in a set-top box (STB) (130). The STB (130) is connected to, for example, a cable network, a satellite dish or other antenna, and receives therefrom the signal (108) to be processed.

The hard disk drive (107) is incorporated in a personal video recorder (PVR) (131). The PVR (131) is a separate unit from the STB (130). Data to be recorded is provided from the STB (130) to the hard drive (107) of the PVR (131) as shown in FIG. 3.

The PVR (131) may also include a decompression device, such as an MPEG2 decoder (104). Consequently, the PVR (131) can retrieve recorded programming from the hard drive (107), decompress the recorded signal and output the decompressed digital signal to the television set (106) for display. In this embodiment, a connection exists between the STB (130) and the PVR (131), between the PVR (131) and the television set (106) and between the STB (130) and the television set (106). This last connection between the STB (130) and the television set (106) is for signals that are being routed directly to the television set (106) for display without recording by the PVR (131).

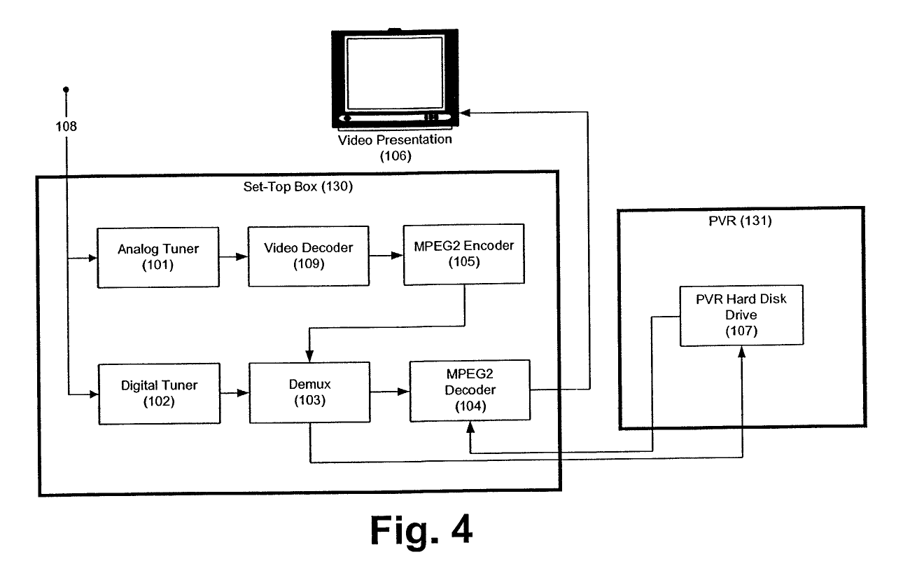

FIG. 4 illustrates a second preferred embodiment for the general system described above in connection with FIG. 2. In the system of FIG. 4, the STB (130) and the PVR (131) are configured to work together to eliminate the need for a connection between the PVR (131) and the television set (106). As shown in FIG. 4, the MPEG2 decoder in the PVR (131) (illustrated in FIG. 3) can be eliminated. Instead, recorded programming retrieved from memory (e.g., 107) by the PVR (131) can be routed back into the STB (130) and to the MPEG2 decoder (104) of the STB (130). Consequently, all output from the system to the television set (106), whether an incoming broadcast or playback of a recorded program, is routed over a single connection between the STB (130) and the television set (106).

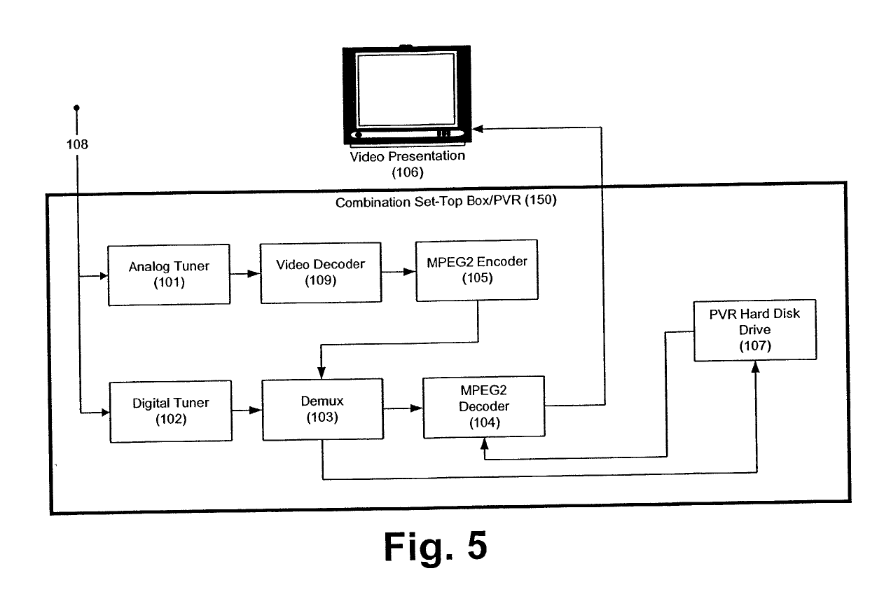

FIG. 5 illustrates a third preferred embodiment for the general system described above in connection with FIG. 2. In the system of FIG. 5, the Set-Top Box and Personal Video Recorder have been integrated into a single unit (150). The interconnections in this unit are similar to those illustrated in FIG. 4. All output from the system (150) to the television set (106), whether an incoming broadcast or playback of a recorded program, is routed over a single connection between the system (150) and the television set (106). This output is routed through the MPEG2 decoder (104) of the system (150).

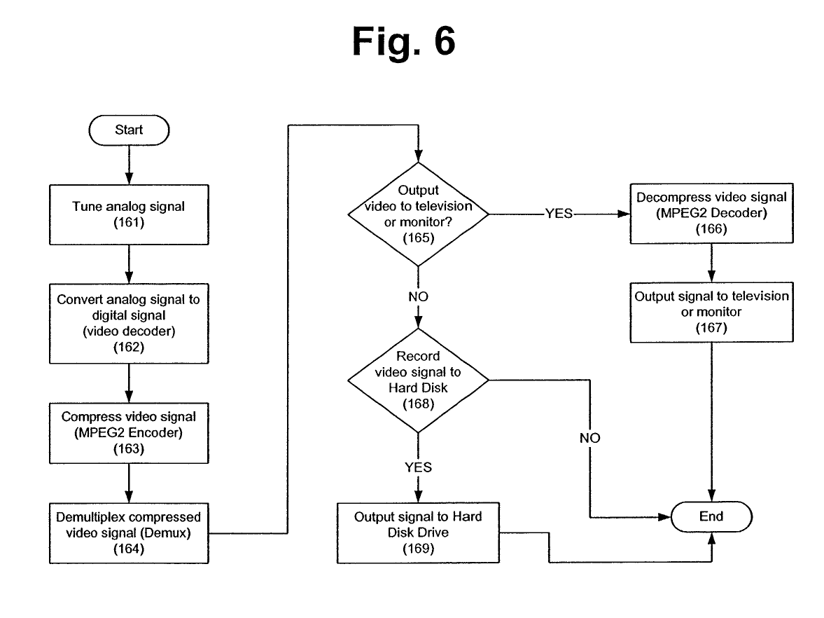

FIG. 6 is a flowchart illustrating a preferred method of the present invention as implemented in the hardware described above. As shown in FIG. 6, the method begins when an analog signal is input and tuned (161). Next, the analog signal is converted to a digital signal for further processing by the system of the present invention (162). After the conversion, the signal is compressed (163), rather than being routed to a television set. The compressed signal is then demultiplexed (164) using a demultiplexer than can be shared by a purely digital signal path.

If the signal is to be output to a television set (165), the signal is decompressed (166) and then output to the connected television (167). Alternatively or additionally, if the signal is to be recorded on a digital recording medium (168), the compressed signal is output to the hard drive or other digital recording medium and stored (169). Upon retrieval, the signal is decompressed and output to a between the PVR (131) and the television set (106). As shown in FIG. 4, the MPEG2 decoder in the PVR (131) (illustrated in FIG. 3) can be eliminated. Instead, recorded programming retrieved from memory (e.g., 107) by the PVR (131) can be routed back into the STB (130) and to the MPEG2 decoder (104) of the STB (130). Consequently, all output from the system to the television set (106), whether an incoming broadcast or playback of a recorded program, is routed over a single connection between the STB (130) and the television set (106).

FIG. 5 illustrates a third preferred embodiment for the general system described above in connection with FIG. 2. In the system of FIG. 5, the Set-Top Box and Personal Video Recorder have been integrated into a single unit (150). The interconnections in this unit are similar to those illustrated in FIG. 4. All output from the system (150) to the television set (106), whether an incoming broadcast or playback of a recorded program, is routed over a single connection between the system (150) and the television set (106). This output is routed through the MPEG2 decoder (104) of the system (150).

FIG. 6 is a flowchart illustrating a preferred method of the present invention as implemented in the hardware described above. As shown in FIG. 6, the method begins when an analog signal is input and tuned (161). Next, the analog signal is converted to a digital signal for further processing by the system of the present invention (162). After the conversion, the signal is compressed (163), rather than being routed to a television set. The compressed signal is then demultiplexed (164) using a demultiplexer than can be shared by a purely digital signal path.

If the signal is to be output to a television set (165), the signal is decompressed (166) and then output to the connected television (167). Alternatively or additionally, if the signal is to be recorded on a digital recording medium (168), the compressed signal is output to the hard drive or other digital recording medium and stored (169). Upon retrieval, the signal is decompressed and output to a

What is claimed is:

1. A television signal processing and recording system for handling both digital and analog video signals, said system comprising:
a video decoder in an analog signal path for converting an analog signal to a digital signal;
an encoder for compressing said digital signal output by said video recorder; and
a connection for routing said compressed digital signal into a digital signal path in which said compressed digital signal is either decompressed with a decoder and output to a television set or recorded on a digital data storage device.

2. The system of claim 1, further comprising a demultiplexer for demultiplexing said compressed digital signal when said compressed digital signal is routed to said digital signal path.

3. The system of claim 2, further comprising a digital tuner for outputting a tuned digital signal into said digital signal path.

4. The system of claim 3, wherein said digital tuner outputs said digital signal to said multiplexer.

5. The system of claim 1, wherein said digital data storage device is a hard disk drive.

6. The system of claim 1, further comprising an analog tuner for outputting said analog signal to said video decoder.

7. The system of claim 1, wherein said encoder is an MPEG2 encoder.

8. The system of claim 1, wherein said decoder is an MPEG2 decoder.

9. The system of claim 1, wherein said decoder, encoder, connection and decoder are incorporated in a set-top box.

10. The system of claim 1, wherein said digital data storage device is incorporated in a personal video recorder.

11. The system of claim 1, wherein said decoder, encoder, connection, decoder and digital data storage device are incorporated in a single set-top unit.

12. A method of processing and recording a television signal that handles both digital and analog video signals, said method comprising:
converting an analog signal to a digital signal; and
compressing and decompressing said digital signal before outputting said digital signal to a television set.

13. The method of claim 12, further comprising, after converting said analog signal to said digital signal and after compressing said digital signal, routing said compressed digital signal from an analog signal path to a digital signal path in which said compressed digital signal is decompressed and output to a television set.

14. The method of claim 13, further comprising demultiplexing said compressed digital signal when said compressed digital signal is routed to said digital signal path.

15. The method of claim 13, further comprising tuning a digital signal with a digital tuner and outputting said tuned digital signal into said digital signal path.

16. The method of claim 12, further comprising, after converting said analog signal to said digital signal and after compressing said digital signal, recording said compressed digital signal on a digital data recording device.

17. The method of claim 16, wherein said converting and compressing said digital signal are performed with a set-top box and said recording is performed by a personal video recorder.

18. A system for processing and recording a television signal that handles both digital and analog video signals, said system comprising:
means for converting an analog signal to a digital signal;
means for compressing and decompressing said digital signal.

19. The system of claim 18, further comprising means for outputting said digital signal to a television set.

20. The system of claim 18, further comprising means for recording said digital signal when said digital signal is compressed.

21. The method of claim 20, wherein said means for converting and for compressing and decompressing said digital signal are housed in a set-top box and said means for recording are housed in a personal video recorder.

22. A television signal processing and recording system for handling both digital and analog video signals, said system comprising:
a video decoder in an analog signal path for converting an analog signal to a digital signal;
an encoder for compressing said digital signal output by said video recorder; and
a decoder for decompressing said digital signal compressed by said encoder.

23. The system of claim 22, further comprising a connection for outputting said digital signal to a television set when said digital signal is decompressed.

24. The system of claim 22, further comprising a digital data storage device for recording said digital signal when compressed by said encoder.

25. The system of claim 22, further comprising a digital tuner for outputting a tuned digital signal to said decoder.

26. The system of claim 22, further comprising an analog tuner for outputting a tuned analog signal to said video decoder.

27. The system of 22, wherein said digital data storage device is a hard disk drive.
